(19) United States
(12) Patent Application Publication
(10) Pub. No.: US 2003/0182140 A1
(43) Pub. Date: Sep. 25, 2003

(54) Owner registration service system and information service method therefor

(76) Inventors: Jun Furuya, Hachioji (JP); Shotaro Tamayama, Tokyo (JP); Takeshi Hoshino, Kodaira (JP)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/224,466

(22) Filed: Aug. 21, 2002

(30) Foreign Application Priority Data
Mar. 20, 2002 (JP) 2002-079491

(51) Int. Cl. G06F 17/60

(52) U.S. Cl. 705/1

(57) ABSTRACT

To an article manufactured by a maker, an ID recognition unit such as a contactless IC microchip in which a unique article ID is stored is attached. In a data base of an owner registration service company, the article information including the article ID and a current owner of an article are registered for each article. When a user purchases an article from a store, the article ID in the ID recognition unit and the personal information in the card for the article are sent to an authentication organ. When the authentication organ requests an updating of the owner to the owner registration service company by these information, the owner registration service company updates the owner information and the like included in the article information associated with the article ID in the data base.

### BACKGROUND OF THE INVENTION

The present invention relates to an owner registration service system and an information service method therefor, in which information on an owner of an article, which has means such as a contactless IC microchip for reading ID (Identification) number unique to the article, is electronically registered to permit cooperation with other services.

In an prior art, an owner of an article such as computer software purchased by him is managed in such a manner that a user registers the ownership of the article together with a serial number unique to the article and the personal information such as the address and name of the owner using the postcard enclosed with the article or through WEB, and the maker grasping the information uses them for after-sale services. Currently, however, the home electric appliances or famous brands of bags, accessories and the like for which no system is available for owner registration, are managed by each owner making a note on the article or based on a ledger.

On the other hand, an article has come to be sold and purchased between individual persons by net auction or the like. The accounts for the sale of this type are settled electronically, while the transfer of the article is completed only upon physical delivery by truck delivery services or mail. In filling up the time lag between the account settlement and the delivery of the article, the purchaser deposits the price in an escrow service or the like which pays, upon complete delivery of the article, the price to the seller, thereby avoiding any troubles which may arise.

In the conventional system described above, when the owner conducts the owner registration for the article after purchasing it, the owner is required to conduct the owner registration procedure for himself. Since this procedure is troublesome for the owner, the owner is often left unregistered.

Also, in view of the fact that the owners are managed for each maker, no means is available by which an owner can search all articles owned by him.

Under the circumstances, neither makers nor owners have any electronic means of owner management for such articles as home electric appliances or bags, accessories and the like for which the owner registration system has not yet been established. The after-sale services for these articles, therefore, are carried out based on a written guarantee or the like. After the protracted use of the article, the written guarantee is often lost.

Further, in the escrow service for the net auction, any services associated with the owner registration to the maker for the guarantee, after-sale services or the like cannot be transferred. Another problem is that it takes a considerable length of time to complete transactions after execution of a purchase agreement until the delivery of the article and the full payment of the charge to the seller.

### SUMMARY OF THE INVENTION

An object of the present invention is to solve these problems and to provide an owner registration service system and an information service method therefor, in which a current owner of an article can always be easily identified and which enables the cooperation with other service systems.

In order to achieve the object described above, according to one aspect of the present invention, there is provided an owner registration service system for performing a service of registering an owner of an article to which a unique article ID is assigned, which comprises: an owner registration service company in which article information including information on the article and information on the owner is registered for each article; and an authentication organ for requesting the owner registration service company to update the owner of the article in transactions for the article; wherein when the transactions for the article are conducted between an individual person and a store or between individual persons, the authentication organ requests the owner registration service company to update the owner of the article, and the owner registration service company updates, based on the request from the authentication organ, the owner information in the article information for the requested article.

The authentication organ has function of settling account for the transactions for the article, and in settling the account, requests the owner registration service company to update the owner of the article which is sold. The authentication organ is, for example, a credit company in a credit payment system.

The article information registered in the owner registration service company further includes history information of owner change, and history information of repair or maintenance.

The owner registration service company supplies the article owner information to other service systems required to know the owner of the article, based on the article information registered.

In response to a request of the owner of the article, the owner registration service company supplies the owner with information on a list of all articles owned by this owner.

According to another aspect of the present invention, there is provided an information service method for an owner registration service system which provides a service based on article information using a data base of the article information including an article ID and personal data of an owner of an article, wherein when the owner of the article is changed, an owner history in the article information stored in the data base is updated; and an updating result of the owner history is supplied to a new owner.

Further, when the owner of the article is changed, the updating result of the owner history is supplied to a maker of the article.

According to still another aspect of the present invention, there is provided an information service method for an owner registration service system which provides a service based on article information using a data base of the article information including an article ID and personal data of an owner of an article, wherein information for guaranteeing a current owner of the article under transactions is supplied based on the article information stored in the data base at time of article transactions between individual persons.

According to yet another aspect of the present invention, there is provided an information service method for an owner registration service system which provides a service based on article information including an article ID and personal data of an owner of an article using a data base storing the article information, wherein information on the owner of the article associated with the ID presented is supplied based on the article information stored in the data base in accordance with the presentation of the article ID.

Only when the article ID is presented together with information for evidencing a searching authority for lost properties, the information on the owner of the article is supplied.

According to a further aspect of the present invention, there is provided an information service method for an owner registration service system which provides a service based on article information including an article ID and personal data of an owner of an article using a data base storing the article information, wherein in response to a request of an owner, a list of all articles of the owner is presented based on the article information stored in the data base and a casualty insurance is applied for on the article designated by the owner in the list.

Other objects, features and advantages of the invention will become apparent from the following description of the embodiments of the invention taken in conjunction with the accompanying drawings.

### BRIEF DESCRIPTION OF THE DRAWINGS

FIG. 1 a diagram showing a general configuration of an owner registration service system and an information service method according to an embodiment of the present invention;

FIG. 2 is a diagram showing a specific example of article information stored in an owner data base shown in FIG. 1;

FIG. 3 is a diagram for explaining an article group component number in FIG. 2;

FIG. 4 is a diagram showing a specific example of a terminal having a reading unit for reading a card and an ID recognition means used in the embodiment shown in FIG. 1;

FIG. 5 is a diagram showing a configuration and an information service method for registering or changing an owner at the time of purchasing an article according to the embodiment shown in FIG. 1;

FIG. 6 is a flowchart showing operation with the configuration shown in FIG. 5 for registering or changing the owner at the time of purchasing the article;

FIG. 7 is a diagram showing a configuration and an information service method wherein the embodiment shown in FIG. 1 is executed in cooperation with a net auction service system;

FIG. 8 is a flowchart showing operation with the configuration shown in FIG. 7;

FIGS. 9A-9C is a diagram showing a specific example of a screen displayed on a personal computer of a user in the operation flow shown in FIG. 8;

FIG. 10 is a diagram showing a configuration and an information service method wherein the embodiment shown in FIG. 1 is executed in cooperation with a lost property owner search system;

FIG. 11 is a flowchart showing operation with the configuration shown in FIG. 10;

FIG. 12 is a diagram showing a configuration and an information service method wherein the embodiment shown in FIG. 1 is executed in cooperation with a casualty insurance service system; and

FIG. 13 is a flowchart showing operation with the configuration shown in FIG. 12.

### DESCRIPTION OF THE EMBODIMENTS

Embodiments of the present invention will be explained below with reference to the drawings.

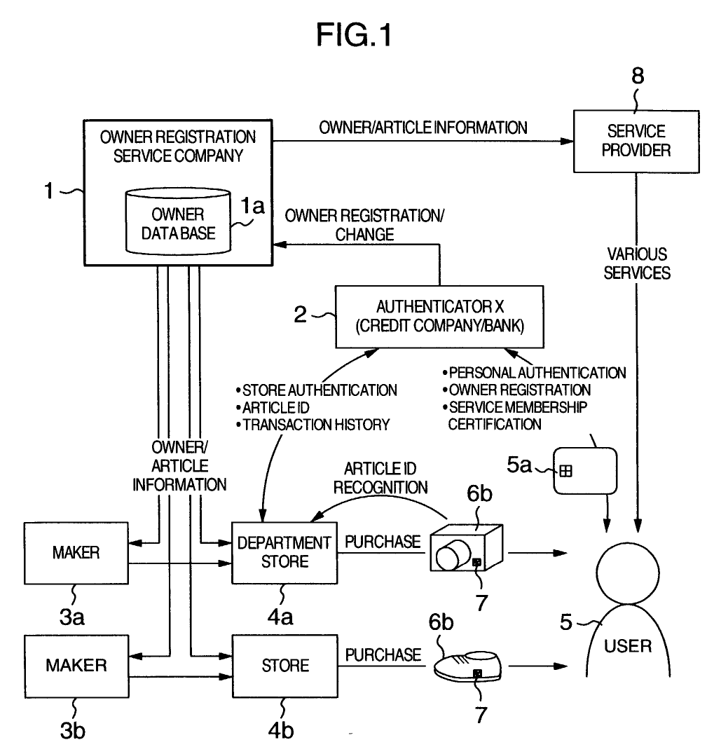

FIG. 1 is a diagram showing a general configuration of an owner registration service system and an information service method according to an embodiment of the present invention. Reference numeral 1 designates an owner registration service company, 1a an owner data base, 2 an authentication organ, 3a and 3b makers, 4a, 4b retail stores, 5 a user, 5a a card, 6a and 6b articles, 7 ID recognition means, and 8 a service provider.

In FIG. 1, the owner registration service company 1 is a nucleus of this service system, and is equipped with the owner data base 1a having registered therein information on articles manufactured and sold by the makers (article information). Each maker, which attaches an identification number unique to an article (hereinafter referred to as “article ID”) for selling the article, sends the article information to the owner registration service company 1. Upon receipt of the article information, the owner registration service company 1 registers it in the owner data base 1a. This registration makes up the initial article information registration.

Assume that the maker 3a manufactures the article 6a which is a “camera” in the following description. The ID recognition means (tiny contactless IC microchip or IPv6, which may be a bar code, assumed to be a “contactless IC microchip” in the following description) 7 stored therein the article ID assigned to the camera 6a is mounted on the camera 6a, so that the initial article information registration is performed in the owner registration service company 1. This registration guarantees that the current owner of the camera 6a is the maker 3a. In similar fashion, upon manufacturing the article 6b (which is assumed to be “shoes”), the maker 3b mounts, on the shoes 6b, a contactless IC microchip 7 stored therein the article ID assigned to the shoes 6b, and performs the initial article information registration in the owner registration service company 1. As the result of this registration, it is guaranteed that the current owner of the shoes 6b is the maker 3b.

Next, assume that the camera 6a is delivered to the retail store 4a (which is assumed to be a “department store”) from the maker 3a. The camera 6a is registered by the department store 4a similarly in the owner registration service company 1. Thus, the article information indicating that the current owner of the camera 6a is the department store 4a is registered in the owner data base 1a, so that it is guaranteed that the department store 4a is the current owner of the camera 6a. In similar fashion, upon delivery of the shoes 6b from the maker 3b to the retail store 4b (which is assumed to be an “ordinary store”), the store 4b registers similar information on the shoes 6b in the owner registration service company 1. Thus, the article information indicating that the current owner of the shoes 6b is the store 4b is registered in the owner data base 1b, thereby guaranteeing that the store 4b is the current owner of the shoes 6b. The transfer of ownership of the camera 6a from the maker 3a to the department store 4a and the ownership of the shoes 6b from the maker 3b to the store 4b is included in the article information in the form of the owner change history information, and stored in the owner data base 1a.

Assume that the user 5 participating in this service system purchases the camera 6a at the department store 4a or the shoes 6b at the store 4b. The user normally uses the card 5a such as a credit card, a debit card or a cash card. In the case where the the transactions for an article are conducted using the card 5a, the user 5 would be personally authenticated or his account settled at a credit company or a bank. In this service system, however, the owner registration service company 1 is requested to register or change the owner for the transactions of the article while the credit company or the bank having the account-settling function acts as the authentication organ 2.

Specifically, on the assumption that the user 5 purchases the camera 6a at the department store 4a using the card 5a, the department store 4a reads the card 5a, and sends the information for personal authentication and registration of the user 5 as an owner and certification of his service membership. At the same time, the article ID of the camera 6a is read from the ID recognition means attached on the camera 6a, and sent to the authentication organ 2 together with the store information for authentication of the department store 4a and the information for transactions of the camera 6a. Thus, the transactions of the camera 6a using the card 5a are established, and the authentication organ 2 registers the owner or the owner change in the owner registration service company based on the transactions. As a result, in the article information for the camera 6a registered in the owner data base 1a, the owner is updated to the user 5 while at the same time adding the owner change history information indicating the transfer of ownership from the department store 4a to the user 5. This also applies to the case in which the user 5 purchases the shoes 6b at the store 4b. In this case, the authentication organ 2 registers the owner and the owner change. Thus, in the article information for the shoes 6b registered in the owner data base 1a, the ownership is updated to the user 5, and the owner change history information is added indicating the transfer of ownership from the store 4b to the user 5.

The user 5 can request the owner registration service company 1 to carry out various services for the camera 6a or the shoes 6b purchased, by using the terminal of the department store 4a or the store 4b. In such a case, the contactless IC microchip 7 or the card 5a of the camera 6a or the shoes 6b, as the case may be, is read at the terminal, and based on the information thus read, the owner registration service company 1 searches the owner data base 1a to authenticate the particular article and the owner thereof. Based on the result of this authentication, the owner registration service company 1 sends the information on the owner and the article to the service provider 8, and requests the service provider 8 to provide various services to the user 5.

Upon the new registration of the owner or at the request of the maker 3a or 3b or the store 4a or 4b, the owner registration service company 1 supplies them with the information on the owner or the article included in the article information described above.

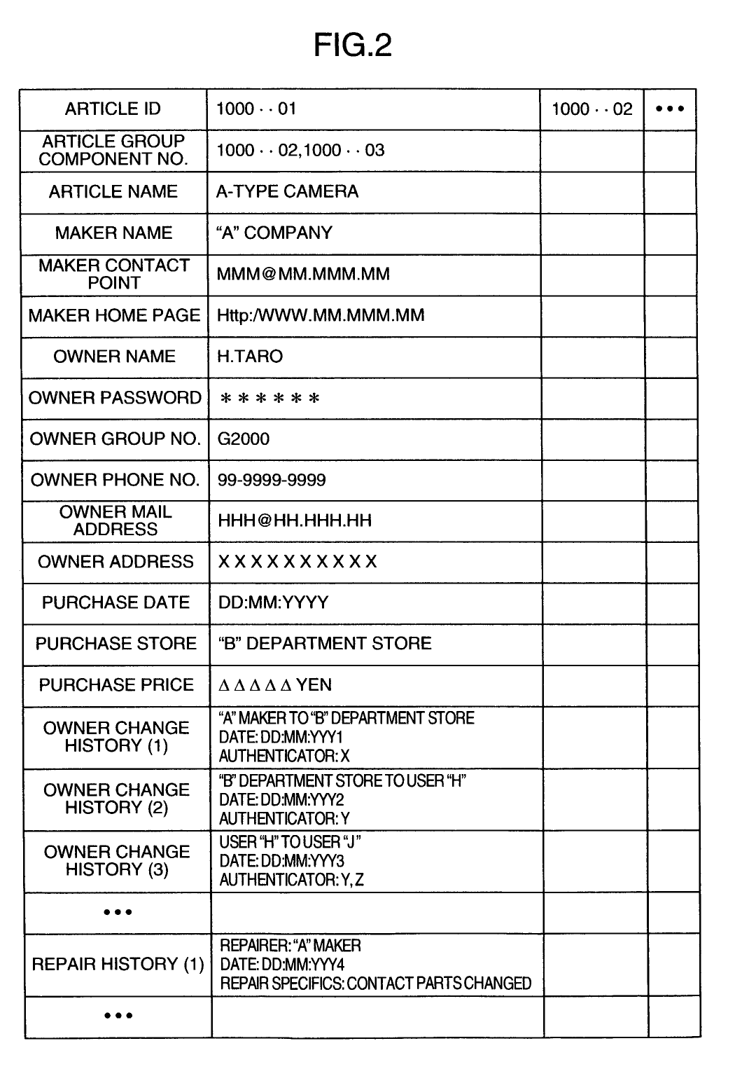

FIG. 2 is a diagram schematically showing a specific example of the article information registered in the owner data base 1a shown in FIG. 1.

In FIG. 2, the article information includes, as shown, the information on the article itself (article ID, article group component number, article name, maker name, maker contact point, maker home page, etc.), the information on the owner (owner name, owner password, owner group component number, owner phone number, owner mail address, owner address, etc.), the information on the latest transactions of the article (date of purchase, store at which the article is purchased, purchase price, etc.), the information on the owner change history, and the information on the article repair/maintenance history.

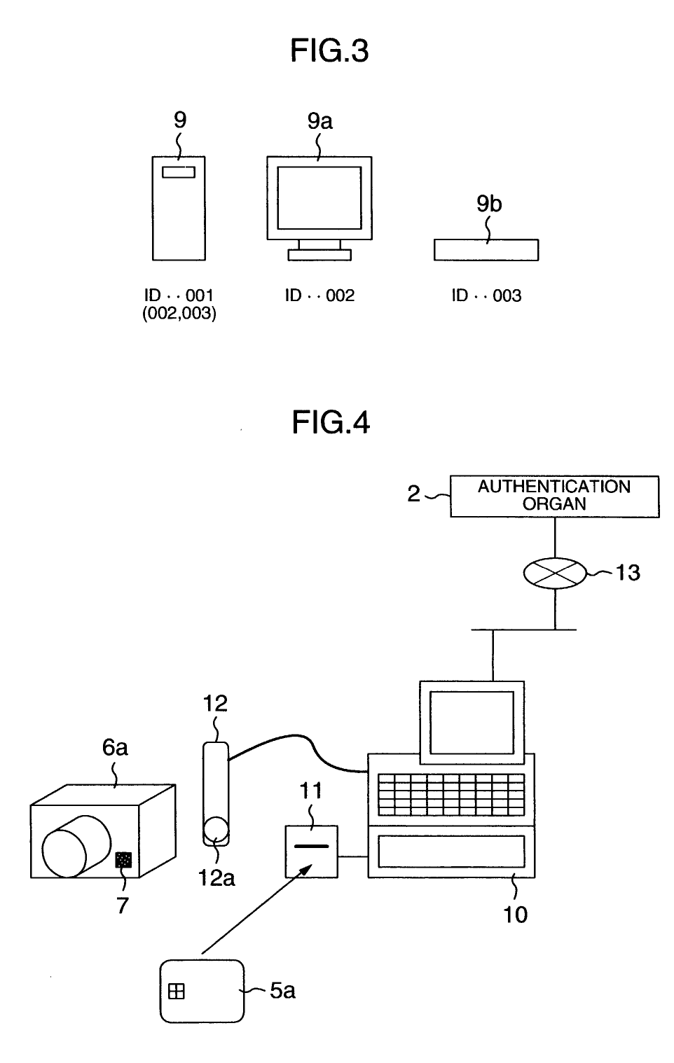

In the case where an article is a combination of a plurality of articles (component articles: each of these articles is manufactured as a commodity to which a unique article ID is assigned and the ID recognition means 7 attached when manufactured by the maker), the article group component number described above indicates the article ID of the component articles. Take a personal computer as an example. A desk-top personal computer includes, as shown in FIG. 3, a computer body 9, a display unit 9a and a keyboard 9b which are used in combination by being connected to each other. In this case, the computer body 9, the display unit 9a and the keyboard 9b combine to make up a personal computer. On the other hand, the computer body 9, the display unit 9a and the keyboard 9b are different commodities from each other and assigned the article IDs of, say, 1000 . . . 01, 1000 . . . 02 and 1000 . . . 03, respectively. For this personal computer, the article ID of the computer body 9 constitutes the “article ID” included in the article information shown in FIG. 2, while the article IDs of the display unit 9a and the keyboard 9b which make up the component parts are the “article group component numbers” in the article information shown in FIG. 2. Thus, an article including only one component article has no “article group component number”.

The owner group number in FIG. 2 indicates the number of the group which the current owner is associated with. In the case where the group is a family, for example, it is the number assigned to the particular family, while in the case of a salaried person, it is the number assigned to his employer organization.

FIG. 4 is a diagram showing the configuration of a specific example of a terminal installed in a retail store or the like for reading the contactless IC microchip 7 or the card 5a. Reference numeral 10 designates a terminal, 11 a card reader, 12 a reader of the contactless IC microchip 7 (hereinafter referred to as the “IC chip reader”), 12a an antenna, and 13 a network. The component parts corresponding to those shown in the drawings described above are designated by the same reference numerals, respectively, and will not be described again.

In FIG. 4, the terminal 10 such as a POS (Point of Sale) terminal is connected to the authentication organ 2 through the network 13. This terminal 10 is equipped with the card reader 11 and the IC chip reader 12. The card 5a is mounted on the card reader 11 and the terminal 10 is operated. The personal information and the information on the service membership certificate in the card 5a are read and supplied to the terminal 10. The IC chip reader 12 has the antenna 12a. When the terminal 10 is operated in such a manner that the antenna 12a approaches the contactless IC microchip 7 of the article such as the camera 6a, the article ID stored in the contactless IC microchip 7 is read by the IC chip reader 12 and sent to the terminal 10. The terminal 10 performs the process for transmitting the input personal information, the information on the service membership certificate and the article ID, and sends them to the authentication organ 2 through the network 13.

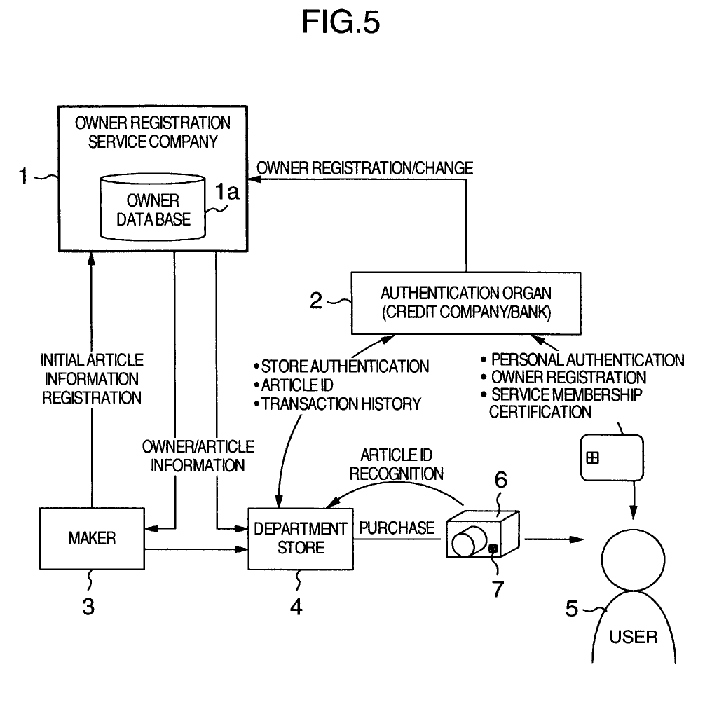

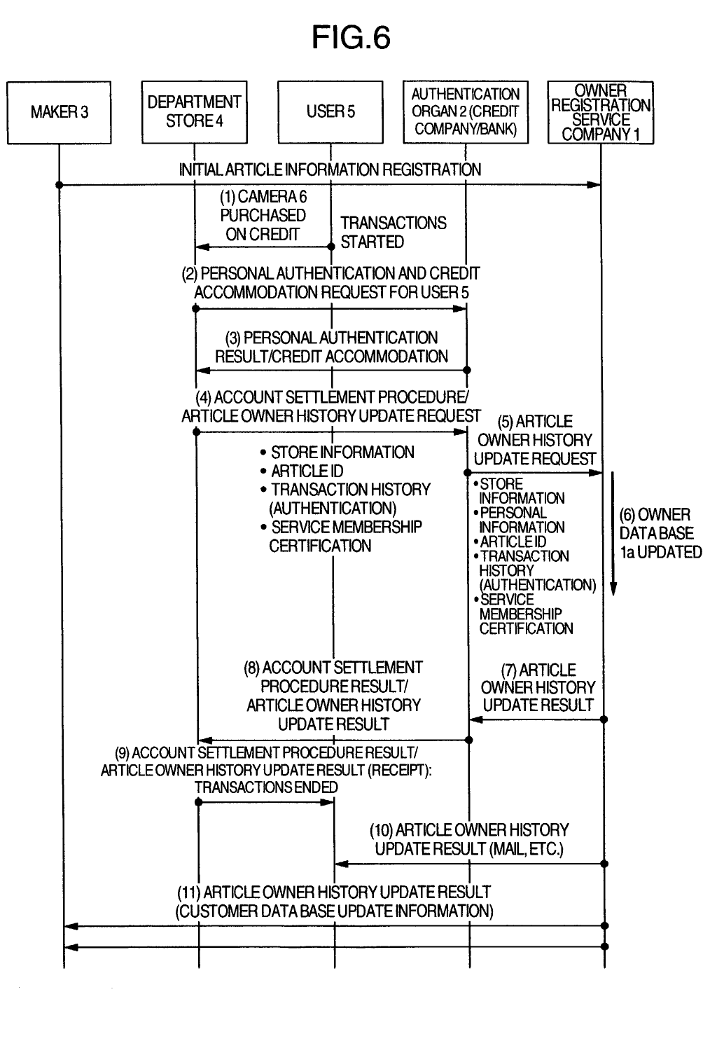

Next, the method of owner registration/change and the information service at the time of article purchase according to the embodiment shown in FIG. 1 will be explained with reference to FIGS. 5 and 6. FIG. 5 shows the component parts required of this embodiment, and FIG. 6 is a flowchart showing the operation involved.

FIG. 5 represents a case in which a camera manufactured by the maker 3 is purchased at the department store 4.

In FIGS. 5 and 6, the camera 6 is put on sale at the department store 4. For this camera 6, therefore, the maker 3 registers the initial article information in the owner registration service company 1. Also, the current owner of the camera 6 is the department store 4.

Assume that the user 5 brings the desired camera 6 from the camera sales floor to the register counter in the department store 4, and, presenting the card 5a, says that he is desirous of buying the camera 6 (i.e. the transactions are started). A person in charge of the register reads, through his terminal, the card 5a and the contactless IC microchip 7 by the camera 6 (step (1)). As a result, a request is sent from the terminal to the authentication organ 2 to give a personal authentication and credit (an inquiry as to whether the transactions should be started or not) for the user 5 (step (2)). In the case where the authentication organ 2 gives the personal authentication and credit in response to the request (step (3)), the person in charge of the register gives an inquiry to the user 5 as to whether or not the owner registration should be carried our for the camera 6.

Upon receipt of an affirmative answer from the user 5, the person in charge of the register performs a predetermined series of operation on the terminal. Thus, a request is sent from the terminal to the authentication organ 4 to settle the account for the camera 6 and to update the registration of the owner (step (4)). At the same time, the store information of the department store 4, the article ID read from the contactless IC microchip 7 of the camera 6, the information on the transactions of the camera 6 (transaction history for authentication), and the information for certifying that the user 5 has the membership of the service system are sent from the same terminal of the department store 4.

The authentication organ 2 receiving these information checks them and settles the account for the camera 6. Further, these information are sent together with the personal information of the user 5 to the owner registration service company 1, and requests it to update the article owner history (step (5)). Based on these information, the owner registration service company 1 updates the article information of the article ID in the owner data base 1a (step (6)), and sends the result of the updating to the authentication organ 2 (step (7)). The authentication organ 2, upon receipt of the result of the updating, sends the result of the account settlement procedure and the result of updating the article owner history to the department store 4 (step (8)). Based on these results, the department store 4 delivers, to the user, a receipt indicating the end of the account settlement and the updating of the owner history, thereby terminating the transactions (step (9)).

After that, the owner registration service company 1 mails or otherwise sends the result of updating the article owner history to the user (step (10)), while at the same time sending the result of updating the article owner history for the camera 6 to the maker 3 (step (11)), thereby ending the whole series of process. In this way, the maker 3 can be kept informed of the current owner of the article 6 manufactured by it, and can utilize the knowledge for after-sale services.

As the result of the series of steps described above, the information ranging from the owner name to the owner address included in the article information of the owner data base 1a as shown in FIG. 2 for the camera 6 (which conventionally includes only the history of owner change from the maker 3 to the department store 4 as the history of owner change) is updated for the user 5. In addition, the information ranging from the purchase date to the purchase price is updated. Further, the history of owner change from the department store 4 to the user 5 is added to the article information.

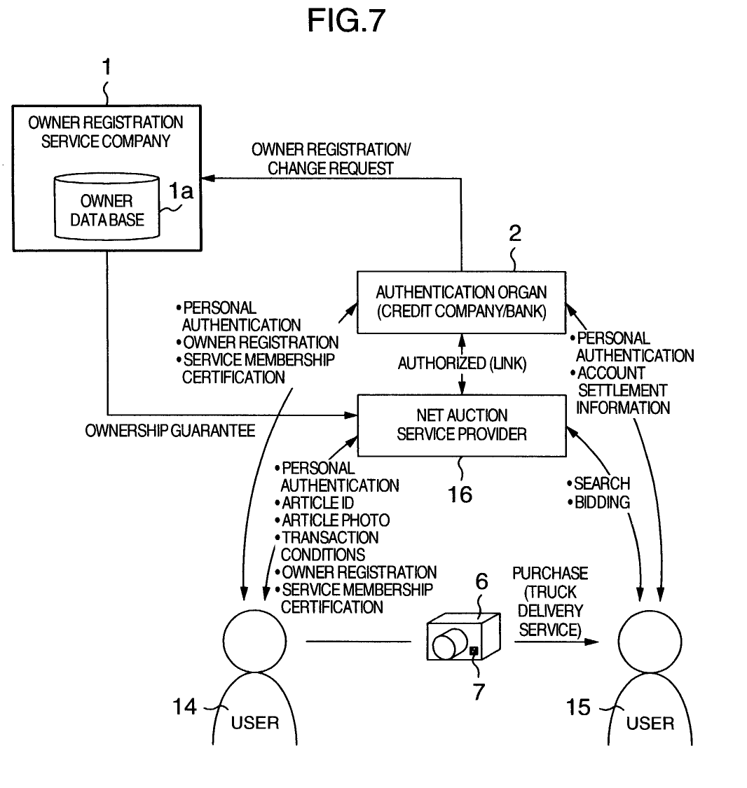

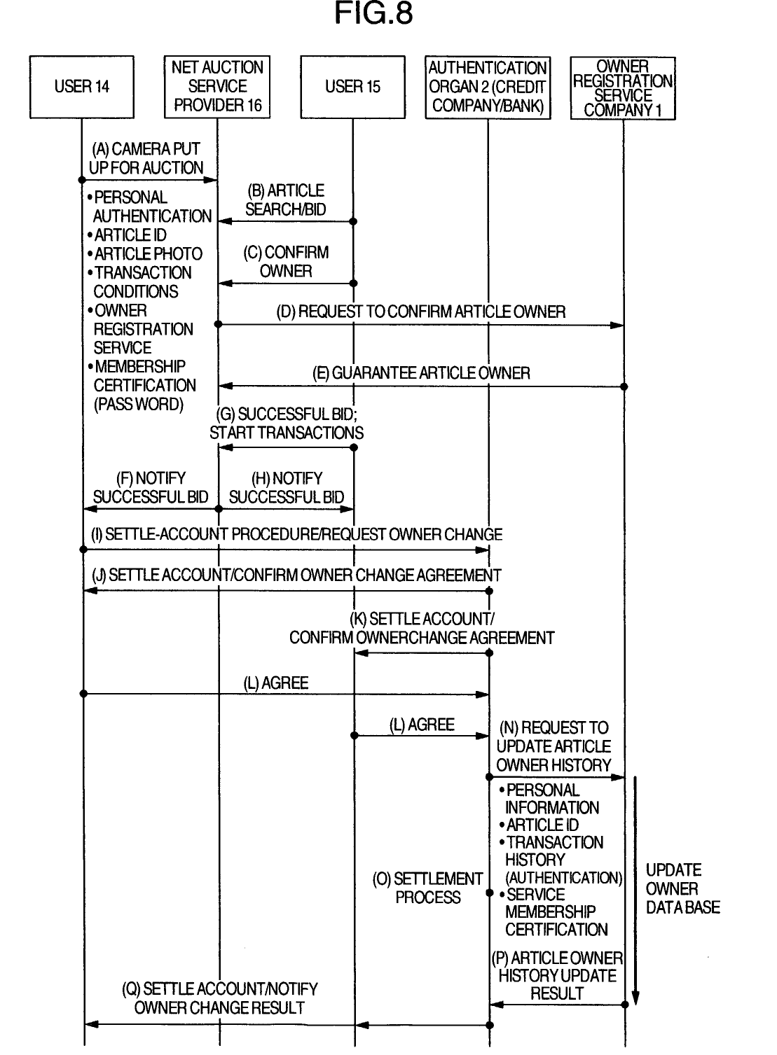

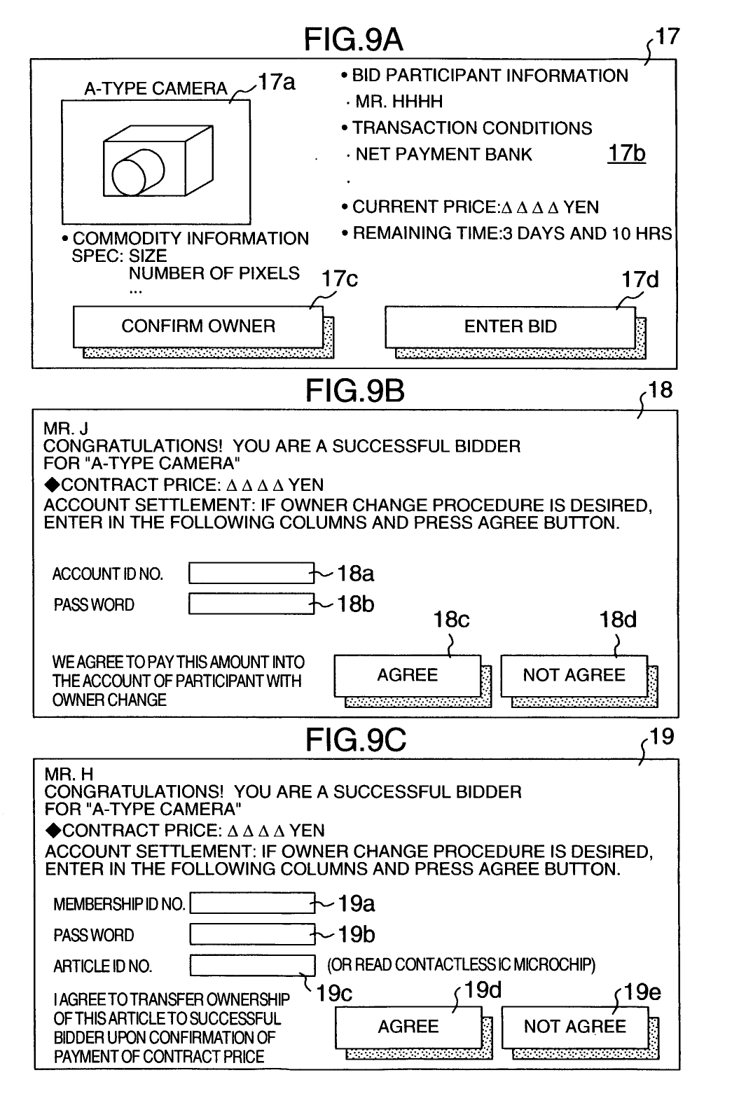

Next, the owner registration/change and the information service method in cooperation with other service systems according to the embodiment shown in FIG. 1 will be explained with reference to FIGS. 7 to 9. Other service systems are assumed to include a net auction service system. FIG. 7 shows the component parts required for the embodiment under consideration with a net auction service system. Reference numerals 14 and 15 designate users, and 16 a net auction service provide (hereinafter referred to as the “NAS provider”). The component parts identical or similar to those shown in the drawings described above are designated by the same reference numerals, respectively, and will not be described again. FIG. 8 is a flowchart showing the operation involved, and FIG. 9 a diagram showing the screen of the personal computer of each user.

As in the case shown in FIG. 7, the camera 6 is assumed to be the article offered for the net auction.

In FIGS. 7 and 8, assume that the user 14 has submitted the camera 6 to the NAS provider 16 for auction. The NAS provider 16 puts it up for net auction through the internet (not shown). In this case, the camera 6 and the photograph thereof are sent from the user 14 to the NAS provider 16 through the internet. At the same time, the user 14 supplies the NAS provider 16 with the information including the personal authentication of the user 14, the article ID and the photograph of the camera 6, the conditions for transaction such as the desired price, and the membership certificate (password) for the owner registration service of the user 14. Based on these information, the NAS provider 16 supplies the auction attendants with the required information through the internet (step (a)).

FIG. 9A shows a specific example of a net auction screen 17 for displaying the photograph 17a of the camera 16 put up for the auction, and the related information including the owner of the camera and the conditions for transactions. At the same time, there are displayed a button 17c for requesting the confirmation of the owner, and a button 17d for notifying the desire to participate in the auction.

The user 15, sequentially switching the net auction screen on his personal computer, searches the articles put up for net auction. In the case where the user 15 desires to purchase the camera 6, he clicks the button 17d on the net auction screen 17 shown in FIG. 9A, thereby notifying the NAS provider 16 of his desire to purchase the camera 6 (step (b)). In the case where the user 15 desires to confirm the owner of the camera 6, on the other hand, he clicks the button 17c (step (c)). Upon receipt of this request for owner confirmation, the NAS provider 16 requests the owner registration service company 1 to confirm the owner of the article using the article ID of the camera 6 and the name of the owner user 14, for example (step (d)). Based on the information on the article ID, this name and the like, the owner registration service company 1 searches the owner data base 1a, and upon confirmation of the owner of the camera 6, the owner registration service company 1 sends to the NAS provider 14 a confirmation guaranteeing that the owner of the camera 6 is the user 14 (step (e)).

The NAS provider 14 sends the result of owner confirmation to the user 15. Upon receipt of the confirmation result, the user 15 notifies the NAS provider 14 of his desire to purchase the article and begins the transactions (step (f)). Once the bid of the user 15 for the camera 6 proves to be successful, the NAS provider 16 notifies the users 15 and 16 that the article is successfully auctioned off (steps (g) and (h)).

FIG. 9B shows a successful bid notification screen 18 for the user 15 who is successful in the auction for the article. On this successful bid notification screen 18, the purchase price is displayed with the notification of the successful bid, while at the same time giving a request to agree to pay the price. In the case where the bidder agrees to pay the price, he inputs the password indicating the account ID number and the membership in predetermined columns 18a and 18b, and notifies the NAS provider 16 of the agreement by clicking the button 18c. In the case where the bidder disagrees on the proposed price, on the other hand, he clicks the button 18d, thereby invalidating the successful bid.

FIG. 9C shows a successful bid notification screen 19 for the user 14 who puts up the camera 6 for auction. On this successful bid notification screen 19, the purchase price is displayed with the notification of the successful bid, while at the same time giving a request to receive the price and agree to change the owner. In the case where the user 14 agrees on them, he inputs the membership ID number, the password and the article ID number in predetermined columns 19a, 19b and 19d, respectively, and notifies the NAS provider 16 of the agreement by clicking the button 19d. In the case where the user 14 disagrees on the conditions, on the other hand, he clicks the button 19e, thereby invalidating the successful bid.

In the case where the users 14 and 15 both agree on the conditions, the NAS provider 16 informs the user 14, who put up the article for auction, that the bid is finally successful, while at the same time notifying the account ID number of the purchaser user 15. Then, the user 14 carries out the procedure for account settlement with the authentication organ 2, and giving a request to change the owner of the camera 6 (step (i)). Upon receipt of the request, the authentication organ 2 confirms with the user 14 whether he agrees on the account settlement and the owner change (step (j)), while at the same time confirming with the user 15 whether he agrees on the account settlement and the owner change (step (k)).

In the case where both parties agree on the account settlement and the owner change (steps (1) and (m), in which case the personal information, the service membership number and the article ID required for changing the owner are sent from each card of the users 14 and 15 to the authentication organ 2), the authentication organ 2 performs the process for account settlement (step (p)) on the one hand and requests the owner registration service company 1 to update the article owner history for the camera 6 by sending thereto the required information (step (n)). The owner registration service company 1 updates the owner data base 1a by removing the article information on the camera 6 therefrom (step (o)), and notifies the result of updating to the authentication organ 2 (step (q)). The authentication organ 2 then informs the users 14 and 15 of the result of updating and the fact that the account has been settled (step (r)), thereby completing the process.

As described above, the cooperation with other service systems makes it possible to confirm the true owner of the article involved, even in the case where the article owner is changed. Also, the article information of the owner data base 1a of the owner registration service company 1 can be updated, thereby keeping the current owner in registration.

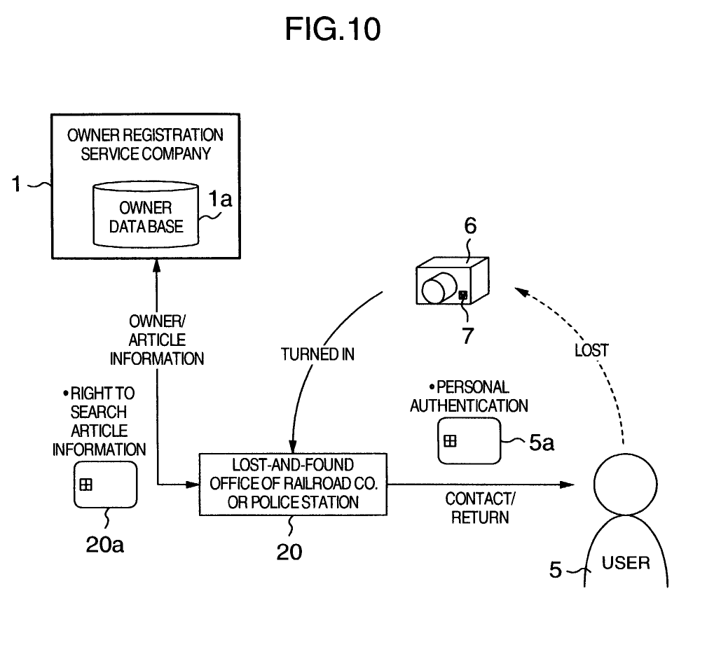

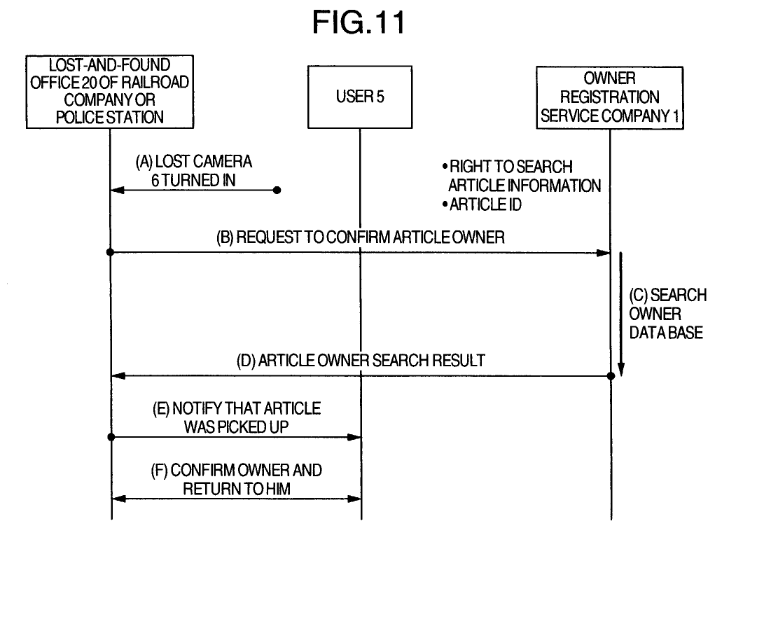

An information service method executed in cooperation with other service systems according to the embodiment shown in FIG. 1 will be explained with reference to FIGS. 10 and 11. Other service systems are assumed to be an owner search system for lost properties. FIG. 10 shows the required component parts of the embodiment and the parts cooperating with the lost property owner search system. Reference numeral 20 designates a lost-and-found office such as a police station or a railroad station. The component parts corresponding to those in the drawings described above are designated by the same reference numerals, respectively, and will not be described again. FIG. 11 is a flowchart showing the related operation.

Also in this case, the lost property is assumed to be the camera 6 as shown in FIG. 10.

In FIGS. 10 and 11, the camera 6 lost by the user 5 is turned in to the lost-and-found office 20 (step (a)). The lost-and-found office office 20 reads the article ID from the contactless IC microchip 7 of the camera 6, and thereby requests the owner registration service company 1 to confirm the owner of the camera 6 (step (b)). This confirmation is to acquire the contents of the owner data base 1a, and can be carried out only by an organization such as the police or the railroad company specifically authorized for search in order to avoid the privacy problem and the like. The lost-and-found office 20 of such an organization has a card 20a stored the information indicating the authorization, for example. Therefore, when the request to confirm the article owner is sent to the owner registration service company 1, the information on the card 20 is also sent to the owner registration service company 1 to certify that the organization is authorized to search the article information.

Upon receipt of the aforementioned request from the lost-and-found office, the owner registration service company 1 searches the owner data base 1a with the article ID given (step (c)), acquires the owner information for the camera 6, and sends the result of the search to the lost-and-found office 20 (step (d)). The lost-and-found office 20 confirms from the search result that the user 5 is the owner, and informs the user 5 that the lost property is found (step (e)). When the user 5 makes appearance to collect the article, the lost-and-found office 20 confirms that he is a true user based on the search result, and returns the camera 6 to him (step (f)).

In this way, by utilizing the information on the current owner of each article registered in the owner registration service company 1, the true owner can be identified immediately and positively, so that the lost and found article can be returned to the true owner without fail.

Other than the owner search system for the lost and found properties described above, there are also service systems required to identify the owner of the article. In cooperation with any of such service systems, the owner registration service company 1 can provide information on the owner of an article whenever required.

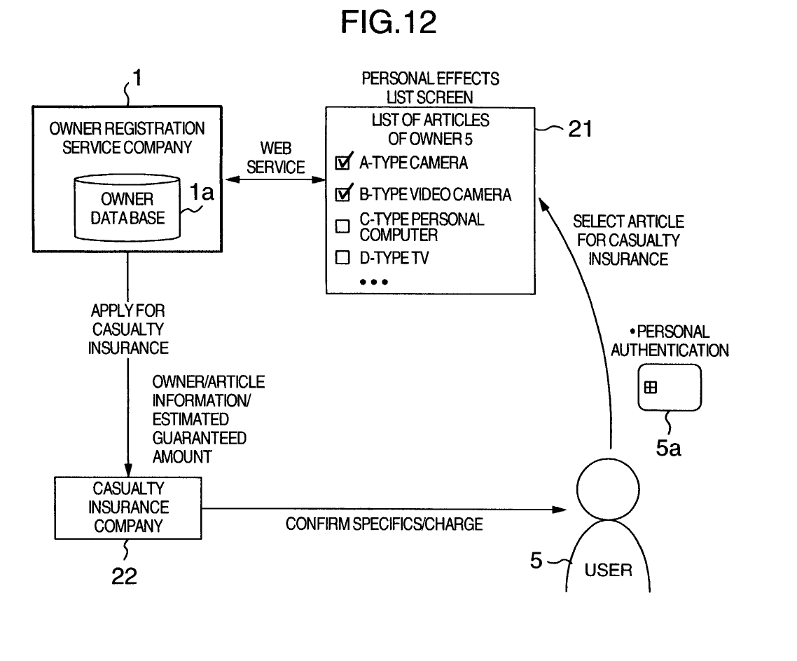

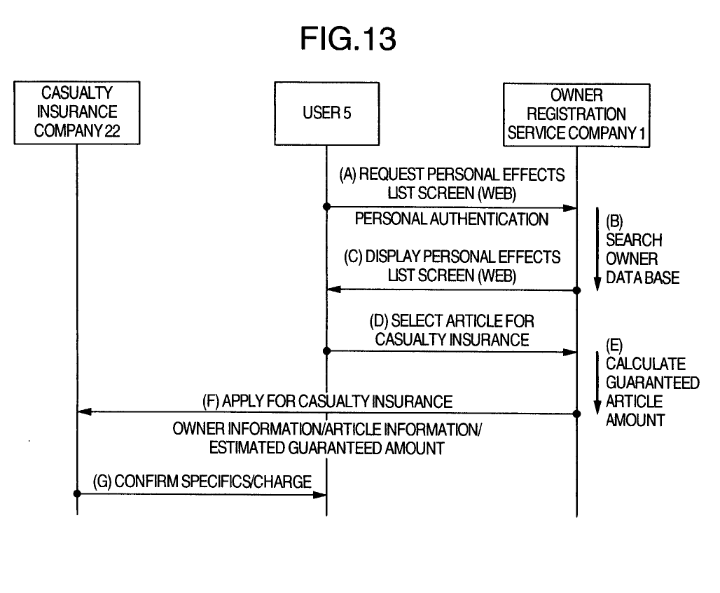

Next, an information service method in which the embodiment shown in FIG. 1 cooperates with another service system will be explained with reference to FIGS. 12 and 13. The other service system is assumed to be a casualty insurance service system. FIG. 12 shows the cooperation parts of this embodiment and the casualty insurance service system. Reference numeral 21 designates a screen showing a list of personal effects, and 22 a casualty insurance company. The component parts corresponding to those in the drawings described above are designated by the same reference numerals, respectively, and will not be described again. FIG. 13 is a flowchart showing the operation involved.

In FIGS. 10 and 11, the user 5 reads his personal information from the card 5a on the personal computer owned by him, and requests a list of the articles owned by him to the owner registration service company 1 through WEB (step A). The owner registration service company 1 searches the owner data base 1a based on this personal information, extracts the articles owned by the user 5, prepares a personal effects list screen 21 (step B), and sends it to the personal computer of the user 5 (step C). As a result, the personal effects list screen 21 as shown is displayed on the screen of the personal computer of the user 5, and an article on which the casualty insurance is to be taken out can be selected. The user 5 selects the required article and requests an application for the casualty insurance (step D). In response to this request, the owner registration service company 1 calculates the guaranteed amount for the selected article (step E), and submits to an insurance company 22 an application for the casualty insurance corresponding to the guaranteed amount thus calculated (step F). The casualty insurance company 22 requests the user 5 to confirm the contents of the insurance application. When the user 5 agree with them, the casualty insurance company 22 requests for charging (step G).

As described above, in view of the fact that the current owner of each article is registered in the owner registration service company 1, each owner can accurately and easily identify all the articles owned by him. Further, in cooperation with the casualty insurance service system, each owner can accurately and easily determine the article on which he desires to take out the casualty insurance.

According to the present invention, since the transactions on the article and the owner registration are performed at the same time, the current true owner of the article is always in registration. Also, the owner registration can be made without any burden on the part of the owner. As a result, the articles of the owners are registered in the increasing proportion, which in turn considerably increases the number of articles managed in registration. This makes it possible for the maker to offer finely detailed after-sale services.

Also, the owner can easily grasp and manage the articles owned by him.

Further, in view of the fact that the owner information of the article can be supplied to another service system in cooperation, the owner of the article can enjoy the finely detailed service also from the other service system.

Furthermore, according to the present invention, for the person-to-person transactions such as a net auction, the owner registration of the article which is to be the target of the transactions can be made. Therefore, for this article, the guarantee and after-sale services are also transferred from the original owner by updating the ownership, thereby making possible safe person-to-person transactions.

It should be further understood by those skilled in the art that although the foregoing description has been made on embodiments of the invention, the invention is not limited thereto and various changes and modifications may be made without departing from the spirit of the invention and the scope of the appended claims.

What is claimed is:

1. An owner registration service system for providing a service for registration of an owner of an article assigned a unique article ID, comprising:
an owner registration service company in which article information is registered, said article information including information on said article and information on said owner of said article; and
an authentication organ for requesting said owner registration service company to update said owner of said article due to transactions of said article; wherein
when transactions of said article are conducted between an individual person and a store or between individual persons, said authentication organ requests said owner registration service company to update said owner of said article; and
said owner registration service company updates, in response to said request from said authentication organ, said information on said owner of said article which is included in said article information of said article.

2. The owner registration service system according to claim 1, wherein
said authentication organ has function of settling an account for the transactions of said article; and
at time of account settlement, said authentication organ requests said owner registration service company to update said owner of said article.

3. The owner registration service system according to claim 2, wherein said authentication organ is a credit company in a credit settlement system.

4. The owner registration service system according to claim 1, wherein said article information registered in said owner registration service company includes information on a history of owner change and information on a history of repair and/or maintenance.

5. The owner registration service system according to claim 2, wherein said article information registered in said owner registration service company includes information on a history of owner change and information on a history of repair and/or maintenance.

6. The owner registration service system according to claim 3, wherein said article information registered in said owner registration service company includes information on a history of owner change and information on a history of repair and/or maintenance.

7. The owner registration service system according to claim 1, wherein said owner registration service company supplies, based on said registered article information, said information on said owner of said article to another service system required to know said owner of said article.

8. The owner registration service system according to claim 2, wherein said owner registration service company supplies, based on said registered article information, said information on said owner of said article to another service system required to know said owner of said article.

9. The owner registration service system according to claim 3, wherein said owner registration service company supplies, based on said registered article information, said information on said owner of said article to another service system required to know said owner of said article.

10. The owner registration service system according to claim 4, wherein said owner registration service company supplies, based on said registered article information, said information on said owner of said article to another service system required to know said owner of said article.

11. The owner registration service system according to claim 1, wherein said owner registration service company supplies said owner of said article with information on a list of all articles owned by said owner, in response to a request of said owner.

12. The owner registration service system according to claim 2, wherein said owner registration service company supplies said owner of said article with information on a list of all articles owned by said owner, in response to a request of said owner.

13. The owner registration service system according to claim 3, wherein said owner registration service company supplies said owner of said article with information on a list of all articles owned by said owner, in response to a request of said owner.

14. The owner registration service system according to claim 4, wherein said owner registration service company supplies said owner of said article with information on a list of all articles owned by said owner, in response to a request of said owner.

15. A information service method used in an owner registration service system, said owner registration service system providing a service based on article information using a data base of said article information, and said article information including an ID of an article and personal data of an owner of said article, comprising the steps of:
updating an owner history using said article information stored in said data base when said article is owned by a new owner; and
informing said new owner of an updating result of said owner history.

16. The information service method according to claim 15, wherein a manufacturer of said article is informed of the updating result of said owner history when said article is owned by said new owner.

17. The information service method according to claim 15, wherein in response to presentation of said ID of said article, information on said owner of said article associated with said ID is supplied based on said article information stored in said data base.

18. The information service method according to claim 17, wherein said information on said owner of said article is supplied only when said ID of said article is presented together with information for evidencing a search authority for a lost property.

19. The information service method according to claim 15, further comprising the steps of:
supplying, in response to a request from said owner of said article, a list of all articles owned by said owner based on said article information stored in said data base; and
providing an application service for a casualty insurance for said article designated by said owner in said list.

20. An information service method used in an owner registration service system, said owner registration service system providing a service based on article information using a data base of said article information, and said article information including an ID of an article and personal data of an owner of said article, comprising the steps of:
searching, when transactions of said article is performed between individual persons, said article information from said data base; and
supplying information for guaranteeing a current owner of said article, which is to be a target of said transactions, based on said searched article information.
